(19) United States
(12) Patent Application Publication
(10) Pub. No.: US 2024/0076166 A1
(43) Pub. Date: Mar. 7, 2024

(54) DESIGN METHOD FOR ELEVATOR, AND ELEVATOR

(71) Applicant: Mitsubishi Electric Corporation, Tokyo (JP)

(72) Inventors: Rikio KONDO, Tokyo (JP); Masaya SERA, Tokyo (JP)

(73) Assignee: Mitsubishi Electric Corporation, Tokyo (JP)

(21) Appl. No.: 18/267,458

(22) PCT Filed: Feb. 1, 2021
(86) PCT No.: PCT/JP2021/003577

§ 371 Date: Jun. 15, 2023

(51) Int. Cl. B66B 19/00; B66B 7/06

(52) U.S. Cl. CPC B66B 19/00; B66B 7/062

(57) ABSTRACT

A main rope of an elevator includes a load support portion made of a composite material of high-strength fiber and resin. A design method for the elevator includes setting a design parameter so that a maximum compressive stress at the load support portion bent along a sheave including a drive sheave and a deflector sheave does not exceed compressive strength, and setting the design parameter so that a sum of a maximum tensile stress at the load support portion bent along the sheave and a mean stress additionally applied to the load support portion when a load required to decelerate a car running in a maximum loading state by gravitational acceleration is applied to the main rope does not exceed tensile strength.

### FIELD

The present disclosure relates to a design method for an elevator, and an elevator.

### BACKGROUND

PTL 1 discloses an example of a drive belt wound on, for example, a drive sheave of an elevator. In the drive belt, a composite material of high-strength fiber and resin, that is, a fiber reinforced plastics (FRP) material is used.

### CITATION LIST

### Patent Literature

[PTL 1] US 2017/0,043,979 A

### SUMMARY

### Technical Problem

Typically, in using a material for a device, it is necessary to consider how the device is used. A main rope of an elevator such as a drive belt is bent by being wound on a sheave such as a drive sheave. When the main rope is bent, while tensile stress can occur on the outside of the bending, compressive stress can occur on the inside of the bending. In the orientation direction of high-strength fiber of an FRP material, strength against the compressive stress is relatively lower than strength against the tensile stress. Thus, in a case in which the FRP material is used in the main rope, even if the side of the main rope subjected to the tensile stress is not damaged, the side subjected to the compressive stress may be damaged.

The present disclosure relates to the solution of such a problem. The present disclosure provides an elevator and a design method for the elevator that can make a main rope made of a composite material less prone to damage.

### Solution to Problem

A design method according to the present disclosure for an elevator, the elevator including a car, a sheave, and a main rope including a load support portion made of a composite material of high-strength fiber and resin, the main rope being wound on the sheave and supporting a load of the car, includes: a compressive stress design step of setting a design parameter for at least any one of the car, the sheave, and the main rope so that a maximum compressive stress at a part of the load support portion, the part being bent along the sheave, does not exceed compressive strength of the load support portion when the main rope supports the car; and a tensile stress design step of setting the design parameter for at least any one of the car, the sheave, and the main rope so that a sum of a maximum tensile stress at the part of the load support portion, the part being bent along the sheave, and a mean stress additionally applied to the load support portion when a load required to decelerate the car running in a maximum loading state by a magnitude equal to gravitational acceleration is applied to the main rope does not exceed tensile strength of the load support portion when the main rope supports the car.

An elevator according to the present disclosure includes: a car; a sheave; and a main rope including a load support portion made of a composite material of high-strength fiber and resin, the main rope being wound on the sheave and supporting a load of the car, wherein a loading load is applied to the main rope so that a maximum compressive stress at a part of the load support portion, the part being bent along the sheave, does not exceed compressive strength of the load support portion when the main rope supports the car and a sum of a maximum tensile stress at the part of the load support portion, the part being bent along the sheave, and a mean stress additionally applied to the load support portion when a load required to decelerate the car running in a maximum loading state by a magnitude equal to gravitational acceleration is applied to the main rope does not exceed tensile strength of the load support portion when the main rope supports the car.

### Advantageous Effects of Invention

The design method and the elevator according to the present disclosure can make the main rope made of the composite material less prone to damage because the compressive stress caused by bending is reduced by the application of the loading load corresponding to the compressive strength and the tensile strength of the main rope.

### BRIEF DESCRIPTION OF DRAWINGS

FIG. 1 is a configuration diagram of an elevator according to a first embodiment.

FIG. 2 is a sectional view of the main rope according to the first embodiment.

FIG. 3 is a side view of the main rope and the sheave according to the first embodiment.

FIG. 4 is a diagram showing an example of position dependency of stress caused by bending in the load support portion according to the first embodiment.

FIG. 5 is a sectional view of a main rope according to a modification of the first embodiment.

FIG. 6 is a diagram showing an example of stress repeatedly applied to a load support portion according to the second embodiment.

FIG. 7 is an example of a fatigue limit diagram of the load support portion according to the second embodiment.

FIG. 8 is a configuration diagram of an elevator according to the third embodiment.

FIG. 9 is a configuration diagram of an elevator according to a modification of the third embodiment.

FIG. 10 is a configuration diagram of an elevator according to another modification of the third embodiment.

### DESCRIPTION OF EMBODIMENTS

Embodiments for carrying out the subject of the present disclosure will be described with reference to the accompanying drawings. Identical reference signs designate identical or corresponding elements throughout the drawings, and redundant description is appropriately simplified or omitted. Note that the subject of the present disclosure is not limited to the following embodiments, and modification of any element of the embodiments or omission of any element of the embodiments can be made without departing from the gist of the present disclosure.

### First Embodiment

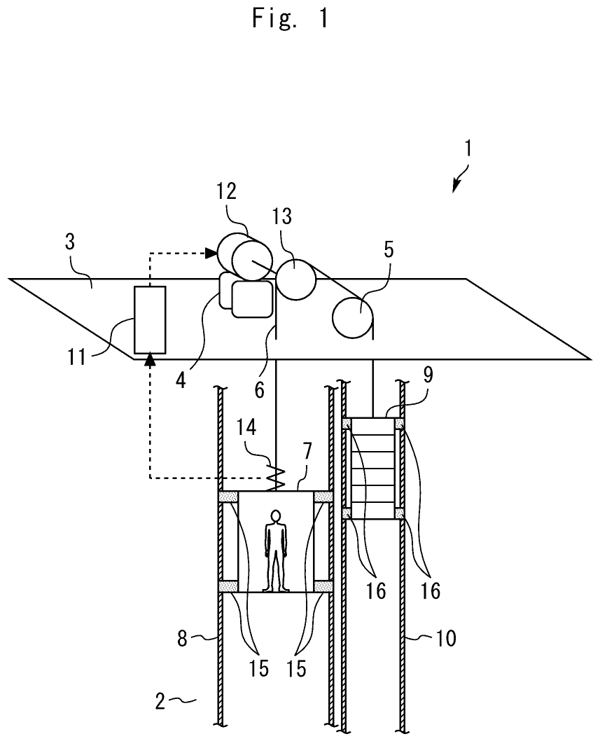

FIG. 1 is a configuration diagram of an elevator 1 according to a first embodiment.

The elevator 1 is applied to, for example, a building having multiple floors. In the building to which the elevator 1 is applied, a hoistway 2 is provided. The hoistway 2 is a space that is long in the up-down direction. In this example, a machine room 3 is provided above the hoistway 2. The elevator 1 includes a traction machine 4, a deflector sheave 5, a main rope 6, a car 7, a car rail 8, a counterweight 9, a counterweight rail 10, and a control panel 11.

The traction machine 4 is positioned, for example, in the machine room 3. In a case in which the machine room 3 of the elevator 1 is not provided, the traction machine 4 may be positioned in an upper part or a lower part of the hoistway 2. The traction machine 4 includes a motor 12 and a drive sheave 13. The motor 12 is a device that generates a driving force. The drive sheave 13 is a device that is rotated by the driving force generated by the motor 12. The drive sheave 13 is an example of the sheave of the elevator 1. The deflector sheave 5 is positioned near the drive sheave 13. The deflector sheave 5 is another example of the sheave of the elevator 1. The diameter of the deflector sheave 5 is, for example, approximately equal to the diameter of the drive sheave 13.

The main rope 6 is a rope-shaped device wound on the drive sheave 13 and the deflector sheave 5. The main rope 6 is, for example, a belt-shaped device. The main rope 6 supports the load of the car 7 on one side of the drive sheave 13. The main rope 6 supports the load of the counterweight 9 on the other side of the drive sheave 13. In this example, the main rope 6 supports the car 7 and the counterweight 9 by suspending the car 7 and the counterweight 9 in a well bucket manner on both sides of the drive sheave 13. One side of the main rope 6 is fed out of the drive sheave 13 by a friction force generated between the main rope 6 and the drive sheave 13 rotated by the motor 12. The other side of the main rope 6 is wound onto the drive sheave 13 by the friction force generated between the main rope 6 and the drive sheave 13 rotated by the motor 12.

The car 7 is a device that runs in the up-down direction in the hoistway 2 to transport a user of the elevator 1 in the up-down direction. The car 7 is positioned in the hoistway 2. The car 7 runs in the up-down direction in conjunction with the main rope 6 moved by the rotation of the drive sheave 13. The car 7 includes a load weighting device 14 and a car guide 15. The load weighting device 14 is a device that detects a loading weight inside the car 7. The car rail 8 is a device that is long in the up-down direction and provided in the hoistway 2. The car rail 8 is a rail that guides the car 7 running in the up-down direction through the car guide 15.

The counterweight 9 is a device balanced with the car 7 so as to strike a balance between the loads on both sides of the drive sheave 13. The counterweight 9 is positioned in the hoistway 2. The counterweight 9 runs to the side opposite to the car 7 in the up-down direction in conjunction with the main rope 6 moved by the rotation of the drive sheave 13. The counterweight 9 includes a counterweight guide 16. The counterweight rail 10 is a device that is long in the up-down direction and provided in the hoistway 2. The counterweight rail 10 is a rail that guides the counterweight 9 running in the up-down direction through the counterweight guide 16.

The control panel 11 is a device that controls operation of the elevator 1. The operation of the elevator 1 controlled by the control panel 11 includes running of the car 7. The control panel 11 is positioned, for example, in the machine room 3. In a case in which the machine room 3 of the elevator 1 is not provided, the control panel 11 may be disposed in the upper part or the lower part of the hoistway 2. On the basis of, for example, the loading weight detected by the load weighting device 14, the control panel 11 obtains a weight difference between the weight of the car 7 including the loading weight and the weight of the counterweight 9. The control panel 11 feeds back the obtained weight difference and controls the rotation of the drive sheave 13 rotated by the motor 12, thereby controlling running of the car.

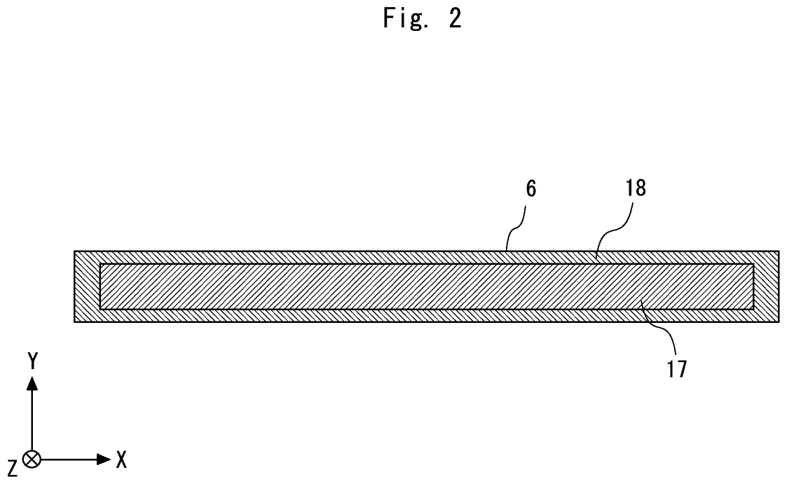

FIG. 2 is a sectional view of the main rope 6 according to the first embodiment.

In FIG. 2, a section on a plane perpendicular to the longitudinal direction of the main rope 6 is shown.

In xyz orthogonal coordinates shown in FIG. 2, a z-axis direction indicates the longitudinal direction of the main rope 6. A y-axis direction indicates the thickness direction of the main rope 6. An x-axis direction indicates the right-left direction of the main rope 6. In a part where the main rope 6 is wound on the drive sheave 13 and bent along the drive sheave 13, the y-axis direction corresponds to the radial direction of the drive sheave 13. In a part where the main rope 6 is wound on the deflector sheave 5 and bent along the deflector sheave 5, the y-axis direction corresponds to the radial direction of the deflector sheave 5.

The main rope 6 includes a load support portion 17 and an outer layer sheath 18. The load support portion 17 is a part that contributes to supporting the load of the car 7. The load support portion 17 is made of a composite material of high-strength fiber and resin, that is, an FRP material. The load support portion 17 is made of an FRP material containing high-strength fiber and base resin combined by impregnation. The high-strength fiber of the load support portion 17 is oriented in the longitudinal direction of the main rope 6. In the FRP material constituting the load support portion 17, the type and combination of the high-strength fiber and the base resin are not limited to any particular type and combination. The high-strength fiber is, for example, carbon fiber, glass fiber, basalt fiber, or polyarylate fiber. The base resin impregnated into the high-strength fiber is, for example, epoxy resin or urethane resin. The outer layer sheath 18 is a part in contact with the sheave of the elevator 1. The outer layer sheath 18 is used, for example, to protect the load support portion 17 and generate the friction force with the sheave. The outer layer sheath 18 does not have to contribute to supporting the load of the car 7.

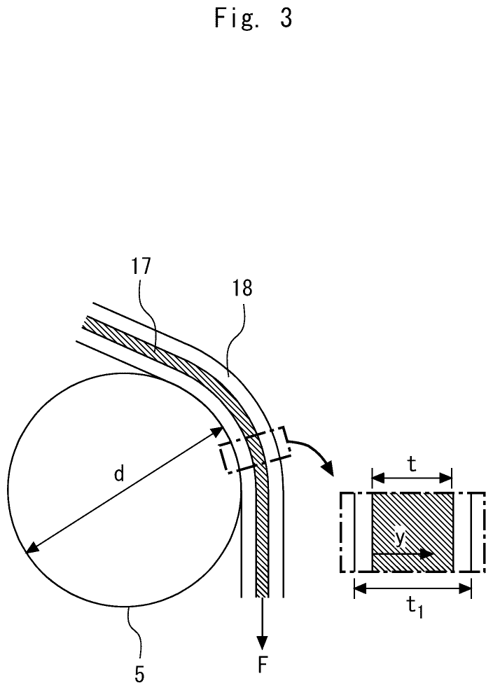

FIG. 3 is a side view of the main rope 6 and the sheave according to the first embodiment.

In FIG. 3, the deflector sheave 5 is shown as an example of the sheave.

In FIG. 3, a diameter d of the deflector sheave 5 as the sheave, a thickness ti in the y-axis direction of the main rope 6, and a thickness tin the y-axis direction of the load support portion 17 are shown. Also, in FIG. 3, a tensile load F applied to the main rope 6 is shown. The tensile load F is, for example, a loading load caused by the load of the car 7 including the loading weight and the load of the counterweight 9. Tensile stress caused by the tensile load F such as the loading load is applied to the main rope 6. In addition to this, since the main rope 6 is bent along the sheave such as the deflector sheave 5, stress caused by such bending is applied to the main rope 6. The stress of such bending applied to the main rope 6 varies depending on a position y in the thickness direction of the main rope 6. In FIG. 3, the position y in the thickness direction of the main rope 6 is shown. The position y is expressed in coordinates with an end face of the load support portion 17 at the side in contact with the sheave such as the deflector sheave 5 as the origin and outside of the sheave in the radial direction as positive.

A vertical stress σ (y) in the longitudinal direction of the main rope 6 applied to the load support portion 17 at the position y is represented by the following expression (1), where stress in the tensile direction is expressed as a positive value and stress in the compressive direction is expressed a negative value. An area A represents the sectional area of the load support portion 17 on a plane perpendicular to the longitudinal direction of the main rope 6. A Young's modulus E represents the Young's modulus of the FRP material constituting the load support portion 17 in the longitudinal direction of the main rope 6. A bending effective diameter D represents a length obtained by adding the thickness ti in the y-axis direction of the main rope 6 to the diameter d of the deflector sheave 5 as the sheave. Note that the tensile stress is defined as an absolute value of the stress in the tensile direction, and the compressive stress is defined as an absolute value of the stress in the compressive direction.

$$\begin{matrix}[ Math . 1 ] & \\ σ ( y ) = \frac{y - \frac{t}{2}}{\frac{D}{2}} E + \frac{F}{A} . & ( 1 )\end{matrix}$$

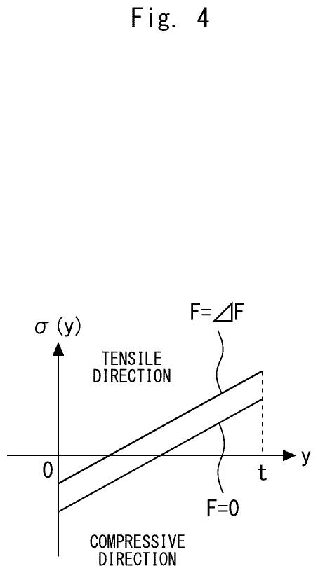

FIG. 4 is a diagram showing an example of position dependency of stress caused by bending in the load support portion 17 according to the first embodiment.

In FIG. 4, the vertical axis represents the vertical stress σ (y) in the longitudinal direction of the main rope 6 applied to the load support portion 17. The horizontal axis represents the position y in the thickness direction of the main rope 6. In FIG. 4, the stress σ (y) in a case in which no tensile load is applied to the main rope 6, that is, F=0 and the stress σ (y) in a case in which the tensile load is applied to the main rope 6, that is, F=ΔF are shown.

In each of the cases in which the tensile load F is F=0 and F=ΔF, the magnitude of the stress in the compressive direction is maximum at the position y=0. Also, in each of the cases in which the tensile load F is F=0 and F=ΔF, the magnitude of the stress in the tensile direction is maximum at the position y=t. On the other hand, while a mean stress is zero in the case in which the tensile load F is F=0, the mean stress is not zero in the case in which the tensile load F is F=ΔF. In the case in which the tensile load F is F=ΔF, while the maximum tensile stress increases, the maximum compressive stress is reduced.

Since the load support portion 17 is made of the FRP material, strength against the compressive stress is lower than strength against the tensile stress in the longitudinal direction. Typically, when the FRP material is simply bent, even if the tensile side subjected to the tensile stress is not damaged, the compressive side subjected to the compressive stress may disadvantageously be damaged. Since the tensile load F such as the loading load is applied to the load support portion 17 of the main rope 6, the maximum compressive stress is reduced, and the possibility of damage on the compressive side can be reduced. On the other hand, since the maximum tensile stress increases, it is necessary to perform system design of the elevator 1 so that the possibility of damage on the tensile side can be reduced.

In the system design, design parameters for the devices of the elevator 1 are set so that conditions for favorable operation of the elevator 1 are satisfied. The devices of the elevator 1 for which the design parameters are set include the main rope 6, the sheave, the car 7, and the counterweight 9. The design parameters are values of, for example, the dimensions, shapes, weights, densities, and mechanical properties of the devices of the elevator 1 that affect the stresses applied to the main rope 6. The mechanical properties include, for example, a modulus of elasticity such as the Young's modulus. More specifically, the design parameters set in the system design include, for example, the Young's modulus E in the longitudinal direction of the load support portion 17, the thickness t of the load support portion 17, the sectional area A of the load support portion 17 on the plane perpendicular to the longitudinal direction, and the bending effective diameter D of the sheave. The design parameters set in the system design also include, for example, the weights of the car 7 and the counterweight 9, and the loading load of the main rope 6 determined depending on the density and length of the main rope 6.

In the system design, the design parameters of the devices of the elevator 1 are set so that at least conditions of the following expression (2) are satisfied. A strength σ_{C} is a negative value representing the strength of the FRP material constituting the load support portion 17 in the compressive direction in the longitudinal direction. A strength σ_{T} is a positive value representing the strength of the FRP material constituting the load support portion 17 in the tensile direction in the longitudinal direction.

$$\begin{matrix}[ Math . 2 ] & \\ \{ \begin{matrix}σ ( 0 ) > {σ}_{C} \\ σ ( t ) < {σ}_{T}\end{matrix} . & ( 2 )\end{matrix}$$

Alternatively, for a design margin, the design parameters for the devices of the elevator 1 may be set in the system design so that conditions of the following expression (3) are satisfied. A margin σ_{C0} (>0) represents a margin for the compressive strength in the longitudinal direction of the FRP material constituting the load support portion 17. A margin σ_{T0} (>0) represents a margin for the tensile strength in the longitudinal direction of the FRP material constituting the load support portion 17.

$$\begin{matrix}[ Math . 3 ] & \\ \{ \begin{matrix}σ ( 0 ) > {σ}_{C} + {σ}_{C 0} \\ σ ( t ) < {σ}_{T} - {σ}_{T 0}\end{matrix} . & ( 3 )\end{matrix}$$

The system design includes a compressive stress design step of setting the design parameters so that the condition of expression (2) or expression (3) for the compressive stress is satisfied and a tensile stress design step of setting the design parameters so that the condition of expression (2) or expression (3) for the tensile stress is satisfied. The compressive stress design step and the tensile stress design step may be performed in parallel, one of the steps may be performed after the other step is performed, or both of the steps may be repeatedly performed.

Also, in the traction elevator 1 as shown in this example, when the traction machine 4 comes to an emergency stop, deceleration is performed at the maximum deceleration to the extent that the main rope 6 does not slip on the drive sheave 13. The magnitude of the maximum deceleration is equal to or less than the magnitude of gravitational acceleration. Thus, in expression (3), a value of the margin σ_{T0} is set to a value of the mean stress applied to the load support portion 17 in addition to a normal loading load when a load required to decelerate the car 7 running in a maximum loading state by a magnitude equal to the gravitational acceleration is applied to the main rope 6. Accordingly, even when the traction machine 4 comes to an emergency stop, damage of the main rope 6 can be prevented. In this case, since the margin σ_{T0} can vary depending on the design parameters for the devices of the elevator 1, the condition of expression (3) for the tensile stress can be modified as in the following expression (4).

[Math. 4]

σ(t)+σ_{T0}<σ_{T}. (4)

As described above, the design method for the elevator 1 according to the first embodiment is a design method for the elevator 1 including the car 7, the sheave including the drive sheave 13 and the deflector sheave 5, and the main rope 6. The main rope 6 includes the load support portion 17. The load support portion 17 is made of the composite material containing high-strength fiber and resin combined by impregnation. The main rope 6 is wound on the sheave. The main rope 6 supports the load of the car 7. The design method includes the compressive stress design step and the tensile stress design step. The compressive stress design step is a step of setting the design parameter so that the maximum compressive stress at a part of the load support portion 17, the part being bent along the sheave, does not exceed the compressive strength of the load support portion 17 when the main rope 6 supports the car 7. In the compressive stress design step, the design parameter for at least any one of the car 7, the sheave, and the main rope 6 is set. The tensile stress design step is a step of setting the design parameter so that the sum of the maximum tensile stress at the part of the load support portion 17, the part being bent along the sheave, and the mean stress additionally applied to the load support portion 17 when the load required to decelerate the car 7 running in the maximum loading state by a magnitude equal to the gravitational acceleration is applied to the main rope 6 does not exceed the tensile strength of the load support portion 17 when the main rope 6 supports the car 7. In the tensile stress design step, the design parameter for at least any one of the car 7, the sheave, and the main rope 6 is set.

The system design of the elevator 1 according to the first embodiment is performed by the above-mentioned design method. In the elevator 1, the loading load is applied to the main rope 6. The loading load is set so that the maximum compressive stress at the part of the load support portion 17 bent along the shave does not exceed the compressive strength of the load support portion 17 when the main rope 6 supports the car 7. Also, the loading load is set so that the sum of the maximum tensile stress at the part of the load support portion 17 bent along the sheave and the mean stress additionally applied to the load support portion 17 when the load required to decelerate the car 7 running in the maximum loading state by a magnitude equal to the gravitational acceleration is applied to the main rope 6 does not exceed the tensile strength of the load support portion 17 when the main rope 6 supports the car 7.

With such as configuration, the loading load that reduces the maximum compressive stress at the load support portion 17 when the main rope 6 is bent is applied to the rope 6. Thus, the main rope 6 including the load support portion 17 that is made of the FRP material and supports the load is less prone to damage. The main rope 6 may include the outer layer sheath 18 so as to be excellent in a property relating to contact with the drive sheave 13 and the deflector sheave 5 such as friction resistance or wear resistance. Also, it is possible to perform the system design of the elevator 1 in accordance with the FRP material constituting the load support portion 17 and also feed the system design back to the design of the FRP material. The mechanical properties can be adjusted by the orientation and density of fibers, the selection of the material, the impregnation method, and the like of the FRP material. Thus, it is possible to increase flexibility in the design of the elevator 1 itself.

In a case in which the diameters of the shaves such as the drive sheave 13 and the deflector sheave 5 differ from each other, the design parameter may be set so that the conditions of expression (2) or expression (3) are satisfied for each of the diameters. Alternatively, the design parameter may be set so that the conditions of expression (2) or expression (3) are satisfied for any one of the sheaves having a smaller diameter.

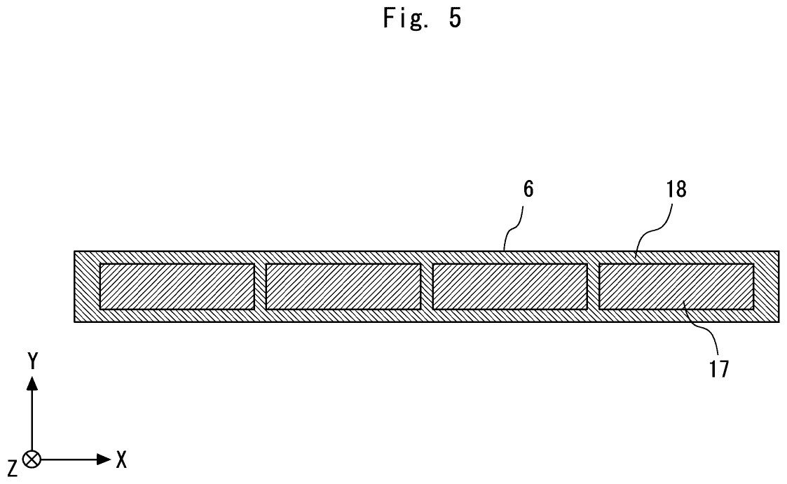

FIG. 5 is a sectional view of a main rope 6 according to a modification of the first embodiment.

In FIG. 5, a section on a plane perpendicular to the longitudinal direction of the main rope 6 is shown.

xyz orthogonal coordinates shown in FIG. 5 are the same as the xyz orthogonal coordinates shown in FIG. 2.

In the main rope 6, the load support portion 17 may be divided into a plurality of parts within the plane perpendicular to the longitudinal direction of the main rope 6. In this example, the load support portion 17 is divided into four parts. The divided parts of the load support portion 17 are collectively covered with the outer layer sheath 18.

### Second Embodiment

In a second embodiment, differences from the example disclosed in the first embodiment will be described particularly in detail. For characteristics that are not described in the second embodiment, any of the characteristics in the example disclosed in the first embodiment may be employed.

In the elevator 1, the car 7 repeatedly reciprocates in the hoistway 2. Thus, the main rope 6 repeatedly passes through the shaves such as the drive sheave 13 and the deflector sheave 5. At this time, the main rope 6 is repeatedly bent. The repetitive bending can cause fatigue failure. Thus, an example of system design for conditions where the main rope 6 is less prone to fatigue failure will be described. The main rope 6 less prone to fatigue failure can reduce the frequency of replacing the main rope 6. This can reduce a burden of maintenance checkup on a manager and a maintainer of the elevator 1.

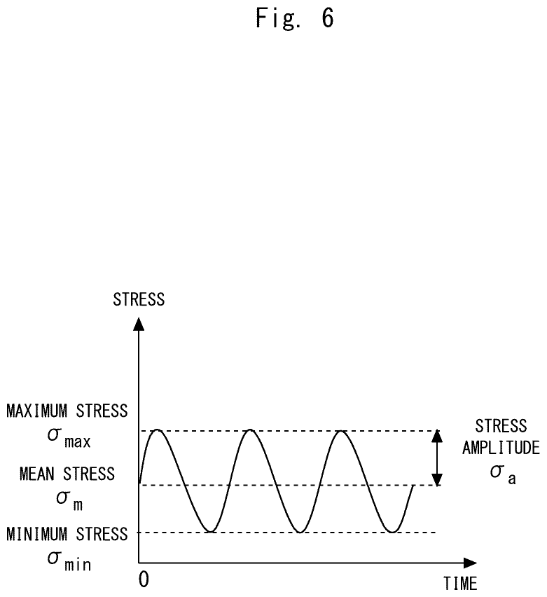

FIG. 6 is a diagram showing an example of stress repeatedly applied to a load support portion 17 according to the second embodiment.

In FIG. 6, the vertical axis represents a vertical stress in the longitudinal direction of the main rope 6 applied to the load support portion 17. In FIG. 6, the horizontal axis represents the passage of time.

As shown in FIG. 6, the stress repeatedly applied to the main rope 6 by bending varies between a maximum stress αₘₐₓ and a minimum stress σₘᵢₙ. Such stress variations are represented by a mean stress σₘ and a stress amplitude σₐ. The mean stress σₘ is represented as σₘ=(σₘₐₓ+σₘᵢₙ)/2. The stress amplitude σₐ is represented as σₐ=(σₘₐₓ−σₘᵢₙ)/2. Typically, fatigue strength under the repeatedly applied load is often organized by a stress ratio R between the maximum stress σₘₐₓ and the minimum stress σₘᵢₙ. The stress ratio R is represented as R=σₘᵢₙ/σₘₐₓ.

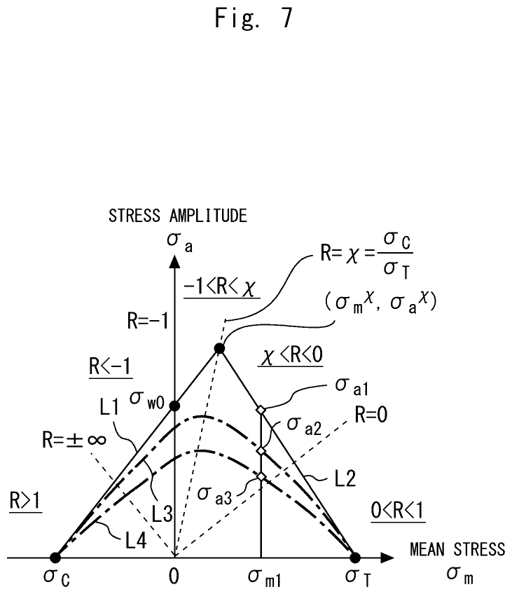

FIG. 7 is an example of a fatigue limit diagram of the load support portion 17 according to the second embodiment.

In FIG. 7, the vertical axis represents the stress amplitude σₐ for the vertical stress in the longitudinal direction of the main rope 6. In FIG. 7, the horizontal axis represents the mean stress σₘ for the vertical stress in the longitudinal direction of the main rope 6.

A solid line L1 and a solid line L2 indicate an N_{f1}-times fatigue strength. An alternate long and short dash line L3 indicates an N_{f2}-times fatigue strength. An alternate long and short dash line L4 indicates an N_{f3}-times fatigue strength. The number of repetitions N_{f1}, N_{f2}, and N_{f3} are integers that satisfy N_{f1}<N_{f2}<N_{f3}. To organize the fatigue strength by the stress ratio R, dashed straight lines indicating R=0, R=−1, R=±∞, and R=χ are shown. A ratio χ between the strength σ_{C} in the compressive direction and the strength σ_{T} in the tensile direction is represented as χ=σ_{C}/σ_{T}. A fatigue strength σ_{W0} is the N_{f1}-times fatigue strength in a case in which the mean stress is zero, that is, the stress ratio is R=−1. The fatigue limit diagram of FIG. 7 shows that, for example, when the mean stress is σₘ₁, fatigue failure occurs at N_{f1} repetitions in the case of stress amplitude σₐ₁, at N_{f2} repetitions in the case of stress amplitude σₐ₂, and at N_{f3} repetitions in the case of stress amplitude σₐ₃. Since the FRP material has differences in the tensile strength and the compressive strength, the fatigue limit diagram is asymmetric with respect to the vertical axis.

As shown in FIG. 7, the fatigue strength is highest at the stress ratio R=χ. The compressive stress and the tensile stress have opposite signs, and the magnitude of the strength σ_{T} in the tensile direction is larger than the magnitude of the strength σ_{c} in the compressive direction in the FRP material. Thus, a value of the ratio χ falls within a range larger than −1 and smaller than 0. Thus, when the stress ratio R is a value within this range in the system design of the elevator 1 including the compressive stress design step and the tensile stress design step, the fatigue strength of the load support portion 17 is high. More preferably, the stress ratio R may be a value close to the ratio χ or a value equal to the ratio χ.

In particular, in a case in which the high-strength fiber of the FRP material constituting the load support portion 17 is carbon fiber, a value of the ratio χ often falls within a range equal to or larger than −0.6 and equal to or smaller than −0.4. Thus, for the elevator 1 including the load support portion 17 made of such an FRP material, when the stress ratio R is a value that falls within this range in the system design of the elevator 1 including the compressive stress design step and the tensile stress design step, the fatigue strength of the load support portion 17 is high.

The N_{f1}-times fatigue strength indicated by the solid lines L1 and L2 is approximately represented by the following expression (5). In the load support portion 17 bent as shown in FIG. 2, a value of the stress σ (y) is minimum at y=0 and maximum at y=t.

$$\begin{matrix}[ Math . 5 ] & \\ {σ}_{a} = \{ \begin{matrix}- \frac{{σ}_{w 0}}{{σ}_{C}} {σ}_{m} + {σ}_{w 0} & ( {σ}_{m} \geq {σ}_{m}^{χ} , solid line L 1 ) \\ - \frac{{σ}_{a}^{χ}}{{σ}_{T} - {σ}_{m}^{χ}} ( {σ}_{m} - {σ}_{T} ) & ( {σ}_{m} < {σ}_{m}^{χ} , solid line L 2 )\end{matrix} . & ( 5 )\end{matrix}$$

Coordinates (σₘ^{χ}, σₐ^{χ}) in FIG. 7 are coordinates of an intersection point of a line indicating the stress ratio R=χ and the N_{f1}-times fatigue strength line, and each component thereof is represented by the following expression (6).

$$\begin{matrix}[ Math . 6 ] & \\ {σ}_{m}^{χ} = \frac{( 1 + χ ) {σ}_{C} {σ}_{w 0}}{( 1 - χ ) {σ}_{C} + ( 1 + χ ) {σ}_{w 0}} , & ( 6 )\end{matrix}$$

$${σ}_{a}^{χ} = \frac{( 1 - χ ) {σ}_{C} {σ}_{w 0}}{( 1 - χ ) {σ}_{C} + ( 1 + χ ) {σ}_{w 0}} .$$

Taking the above relationship into consideration, it is possible to obtain the elevator 1 that can prevent the strength of the main rope 6 from being reduced by fatigue caused by bending by determining the stress amplitude σₐ and the mean stress σₘ on the basis of the stress ratio. The stress amplitude σₐ is determined by the Young's modulus E in the longitudinal direction of the load support portion 17, the thickness t of the load support portion 17, and the bending effective diameter D of the sheave. The mean stress σₘ is determined by these design parameters and the loading load of the main rope 6.

In the well bucket elevator 1 as shown in FIG. 1, the main rope 6 is bent in the same direction when passing through the drive sheave 13 and when passing through the deflector sheave 5. Thus, the load support portion 17 is bent only in one direction. At the position y of the load support portion 17 bent only in one direction, repetitive stress with the stress amplitude σₐ (y) and the mean stress σₘ (y), which are represented by the following expression (7), acts on the main rope 6 in the longitudinal direction.

$$\begin{matrix}[ Math . 7 ] & \\ {σ}_{a} ( y ) = \frac{\vert y - \frac{1}{2} t \vert}{D} E , & ( 7 )\end{matrix}$$

$${σ}_{m} ( y ) = \frac{F}{A} + \frac{y - \frac{1}{2} t}{D} E .$$

From expression (7), the magnitude of the stress amplitude σₐ (y) is maximum at y=0 and y=t. The magnitude of the stress amplitude σₐ (y) at this time is tE/2D.

If the margin for fatigue failure is high only on either the tensile side or the compressive side, damage on the side having a low margin may lead to replacement of the main rope 6 itself. Thus, margins on both the tensile side and the compressive side are preferably approximately equal to each other. Thus, in the system design of the elevator 1 including the compressive stress design step and the tensile stress design step, the design parameter is set so that the following expression (8) is satisfied. A stress amplitude σₐ₀ and a mean stress σₘ₀ are a stress amplitude and a mean stress obtained by setting y=0 in expression (7). A strength σₐ₀ₘₐₓ is the N_{f1}-times fatigue strength obtained by setting σₘ=σₘ₀ in expression (4). A stress amplitude σₐₜ and a mean stress σₘₜ are a stress amplitude and a mean stress obtained by setting y=t in expression (7). A strength σₐₜₘₐₓ is the N_{f1}-times fatigue strength obtained by setting σₘ=σₘₜ in expression (4).

$$\begin{matrix}[ Math . 8 ] & \\ \frac{{σ}_{a 0}}{{σ}_{a 0 max}} \approx \frac{{σ}_{a t}}{{σ}_{at max}} . & ( 8 )\end{matrix}$$

In the system design, when the condition that makes both sides of expression (8) equal is satisfied, margins on both the tensile side and the compressive side are equal to each other, which is more preferred.

As described above, the design method for the elevator 1 according to the second embodiment is a method for setting the design parameter so that a value of the stress ratio R of the load support portion 17 falls within the range larger than −1 and smaller than 0 in each of the compressive stress design step and the tensile stress design step. At least any one of the Young's modulus E of the load support portion 17 in the longitudinal direction of the main rope 6, the thickness t of the load support portion 17 in the radial direction of the sheave of the elevator 1, the bending effective diameter D of the sheave, and the loading load of the main rope 6 is set as the design parameter. In addition, the system design of the elevator 1 according to the second embodiment is performed by the above-mentioned design method.

Such a configuration increases the fatigue strength of the load support portion 17. Also, the range of the value of the stress ratio R larger than −1 and smaller than 0 is a range in which application of partially reversed repetitive load leaning toward the tensile side is performed. Since the FRP material constituting the load support portion 17 has higher strength against the tensile stress than against the compressive stress, reduction in the life of the main rope 6 caused by bending can be prevented.

The high-strength fiber of the load support portion 17 may include carbon fiber. In this case, the design method for the elevator 1 may be a method for setting the design parameter so that a value of the stress ratio R of the load support portion 17 falls within a range equal to or larger than −0.6 and equal to or smaller than −0.4 in each of the compressive stress design step and the tensile stress design step. At least any one of the Young's modulus E of the load support portion 17 in the longitudinal direction of the main rope 6, the thickness t of the load support portion 17 in the radial direction of the sheave of the elevator 1, the bending effective diameter D of the sheave, and the loading load of the main rope 6 is set as the design parameter.

Such a configuration can make the main rope 6 of the elevator 1 less prone to fatigue failure in accordance with the characteristics of the load support portion 17.

### Third Embodiment

In a third embodiment, differences from the example disclosed in the first embodiment or the second embodiment will be described particularly in detail. For characteristics that are not described in the third embodiment, any of the characteristics in the example disclosed in the first embodiment or the second embodiment may be employed.

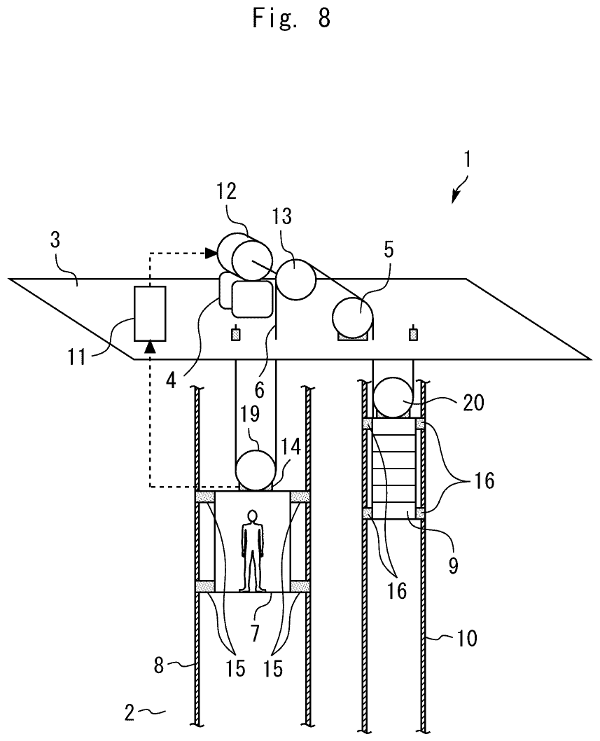

FIG. 8 is a configuration diagram of an elevator 1 according to the third embodiment.

Both ends of a main rope 6 are fixed to, for example, a machine room 3. In a case in which the machine room 3 of the elevator 1 is not provided, both the ends of the main rope 6 may be fixed to an upper part of a hoistway 2.

A car 7 includes a car sheave 19. The car sheave 19 is an example of the sheave of the elevator 1 on which the main rope 6 is wound. The car 7 is supported by the main rope 6 wound on the car sheave 19.

A counterweight 9 includes a counterweight sheave 20. The counterweight sheave 20 is an example of the sheave of the elevator 1 on which the main rope 6 is wound. The counterweight 9 is supported by the main rope 6 wound on the counterweight sheave 20.

In the elevator 1 with the roping as shown in FIG. 8, a direction in which the main rope 6 is bent when passing through a drive sheave 13 and when passing through a deflector sheave 5 and a direction in which the main rope 6 is bent when passing through the car sheave 19 and when passing through the counterweight sheave 20 differ from each other. Thus, a load support portion 17 is bent in both directions for the thickness direction. Since the load support portion 17 is bent in both directions, both the compressive stress and the tensile stress are applied to each part. In the load support portion 17 bent in both directions, a stress amplitude σₐ (y) and a mean stress σₘ (y) in the longitudinal direction of the main rope 6 at a position y are represented by the following expression (9).

$$\begin{matrix}[ Math . 9 ] & \\ {σ}_{a} ( y ) = \frac{\vert y - \frac{1}{2} t \vert}{\frac{D}{2}} E , & ( 9 )\end{matrix}$$

$${σ}_{m} ( y ) = \frac{F}{A} .$$

From expression (9), the magnitude of the maximum stress is maximum at y=0 and y=t. A stress ratio R at this time is represented by the following expression (10).

$$\begin{matrix}[ Math . 10 ] & \\ R = \frac{\frac{F}{A} - \frac{tE}{D}}{\frac{F}{A} + \frac{tE}{D}} . & ( 10 )\end{matrix}$$

Thus, in the system design of the elevator 1 including the compressive stress design step and the tensile stress design step, the design parameter is set so that the stress ratio R represented by expression (10) is close to a ratio χ. Accordingly, the elevator 1 is operated under conditions that achieve higher fatigue strength.

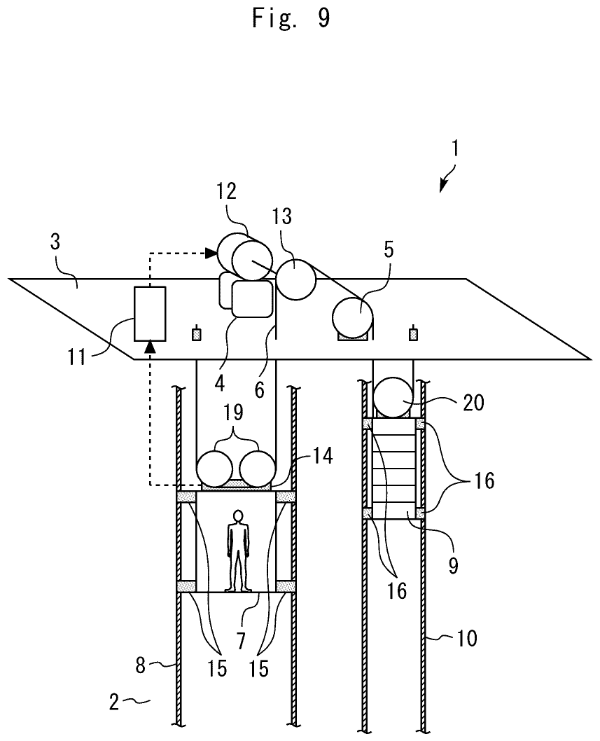

FIG. 9 is a configuration diagram of an elevator 1 according to a modification of the third embodiment.

A car 7 includes two car sheaves 19. In such a configuration, the load support portion 17 of the main rope 6 is bent in both directions. Thus, the system design of the elevator 1 can be performed using expression (10).

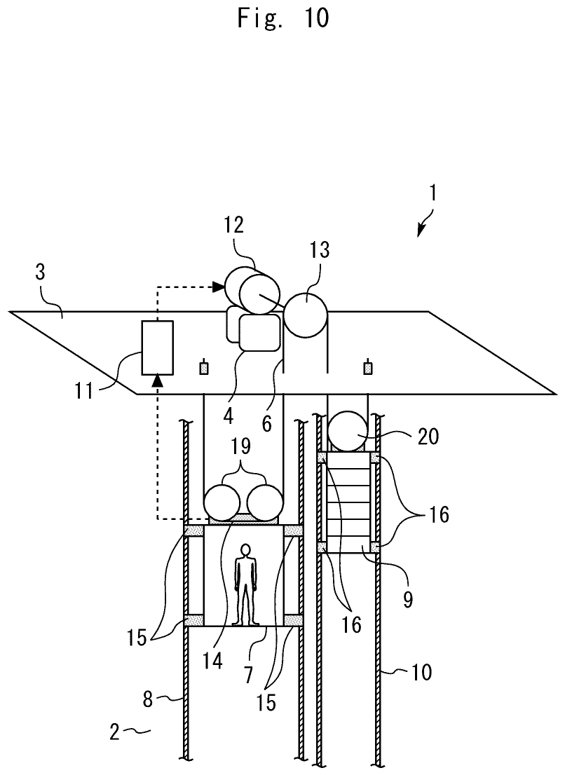

FIG. 10 is a configuration diagram of an elevator 1 according to another modification of the third embodiment.

The elevator 1 may not include the deflector sheave 5. In such a configuration, the load support portion 17 of the main rope 6 is bent in both directions. Thus, the system design of the elevator 1 can be performed using expression (10).

### INDUSTRIAL APPLICABILITY

The elevator according to the present disclosure is applicable to a building having multiple floors. The design method according to the present disclosure is applicable to the elevator.

### REFERENCE SIGNS LIST

1 Elevator, 2 Hoistway, 3 Machine room, 4 Traction machine, 5 Deflector sheave, 6 Main rope, 7 Car, 8 Car rail, 9 Counterweight, 10 Counterweight rail, 11 Control panel, 12 Motor, 13 Drive sheave, 14 Load weighting device, 15 Car guide, 16 Counterweight guide, 17 Load support portion, 18 Outer layer sheath, 19 Car sheave, 20 Counterweight sheave

1.-3. (canceled)

4. An elevator comprising:
a car;
a sheave; and
a main rope including a load support portion made of a composite material of high-strength fiber and resin, the main rope being wound on the sheave and supporting a load of the car, wherein
a loading load is applied to the main rope so that a maximum compressive stress at a part of the load support portion, the part being bent along the sheave, does not exceed compressive strength of the load support portion when the main rope supports the car and a sum of a maximum tensile stress at the part of the load support portion, the part being bent along the sheave, and a mean stress additionally applied to the load support portion when a load required to decelerate the car running in a maximum loading state by a magnitude equal to gravitational acceleration is applied to the main rope does not exceed tensile strength of the load support portion when the main rope supports the car; and
a value of a stress ratio of the load support portion falls within a range larger than −1 and smaller than 0.

5. A design method for an elevator,
the elevator including
a car,
a sheave, and
a main rope including a load support portion made of a composite material of high-strength fiber and resin, the main rope being wound on the sheave and supporting a load of the car,
the method comprising:
setting a design parameter for at least any one of the car, the sheave, and the main rope so that a maximum compressive stress at a part of the load support portion, the part being bent along the sheave, does not exceed compressive strength of the load support portion when the main rope supports the car; and
setting the design parameter for at least any one of the car, the sheave, and the main rope so that a sum of a maximum tensile stress at the part of the load support portion, the part being bent along the sheave, and a mean stress additionally applied to the load support portion when a load required to decelerate the car running in a maximum loading state by a magnitude equal to gravitational acceleration is applied to the main rope does not exceed tensile strength of the load support portion when the main rope supports the car, wherein,
at least any one of a Young's modulus of the load support portion in a longitudinal direction of the main rope, a thickness of the load support portion in a radial direction of the sheave, a bending effective diameter of the sheave, and a loading load of the main rope is set as the design parameter so that a value of a stress ratio of the load support portion falls within a range larger than −1 and smaller than 0.

6. A design method for an elevator,
the elevator including
a car,
a sheave, and
a main rope including a load support portion made of a composite material of high-strength fiber and resin, the main rope being wound on the sheave and supporting a load of the car,
the method comprising:
setting a design parameter for at least any one of the car, the sheave, and the main rope so that a maximum compressive stress at a part of the load support portion, the part being bent along the sheave, does not exceed compressive strength of the load support portion when the main rope supports the car; and
setting the design parameter for at least any one of the car, the sheave, and the main rope so that a sum of a maximum tensile stress at the part of the load support portion, the part being bent along the sheave, and a mean stress additionally applied to the load support portion when a load required to decelerate the car running in a maximum loading state by a magnitude equal to gravitational acceleration is applied to the main rope does not exceed tensile strength of the load support portion when the main rope supports the car, wherein,
at least any one of a Young's modulus of the load support portion in a longitudinal direction of the main rope, a thickness of the load support portion in a radial direction of the sheave, a bending effective diameter of the sheave, and a loading load of the main rope is set as the design parameter so that a value of a stress ratio of the load support portion is approximately equal to a value of a ratio of a negative value of strength in a compressive direction to a positive value of strength in a tensile direction of the load support portion.
